(19) United States
(12) Patent Application Publication
(10) Pub. No.: US 2025/0030183 A1
(43) Pub. Date: Jan. 23, 2025

(54) LINE CARRIER

(71) Applicant: Phoenix Contact GmbH & Co. KG, Blomberg (DE)

(72) Inventors: Manuela PAUS, Muenster (DE); Michael PETER, Lage (DE); Kilian KLAGES, Detmold (DE)

(21) Appl. No.: 18/710,204

(22) PCT Filed: Nov. 14, 2022
(86) PCT No.: PCT/EP2022/081822

§ 371 Date: May 15, 2024

(30) Foreign Application Priority Data
Nov. 17, 2021 (DE) 10 2021 130 044.4
Jan. 21, 2022 (BE) BE2022/5039
Jan. 21, 2022 (DE) 10 2022 101 366.9

(51) Int. Cl. H01R 9/24; H01R 43/18

(52) U.S. Cl. CPC H01R 9/24; H01R 43/18

(57) ABSTRACT

A terminal block includes: a line with a main part on which the line is arranged, the main part having a first portion including a polymer composition. At least one component of the polymer composition includes at least one of: secondary polymer raw material, biodegradable polymer, bio-based polymer. In an embodiment, at least a first portion includes the polymer composition, and a second portion includes a different material having a second polymer.

### CROSS-REFERENCE TO PRIOR APPLICATIONS

This application is a U.S. National Phase application under 35 U.S.C. § 371 of International Application No. PCT/EP2022/081822, filed on Nov. 14, 2022, and claims benefit to German Patent Application No. DE 10 2021 130 044.4, filed on Nov. 17, 2021, German Patent Application No. DE 10 2022 101 366.9, filed on Jan. 21, 2022, and Belgian Patent Application No. BE 2022/5039, filed on Jan. 21, 2022. The International Application was published in German on May 25, 2023 as WO/2023/088844 under PCT Article 21(2).

### FIELD

The invention relates to a terminal block for lines, in particular for transmitting electrical energy and/or electrical/photometric signals/data. Furthermore, the invention comprises a method for producing the terminal block, and the use of a material for a terminal block.

### BACKGROUND

Terminal blocks of the type in question are provided with a line and a main part on which the line is arranged. In these, the main part has at least one first portion which consists of a first polymer or has such a polymer. They are used to provide lines for the transfer of media, in particular fluids, as well as electrical/photonic energies such as electrical currents, signals and data in a main part. Such terminal blocks are therefore known in a variety of forms and can be used for different purposes.

Terminal blocks of the type in question have established particular importance in the electrotechnical industry where they are used, for example and in particular to hold lines, be they electrical cables, photonic conductors and conductors used on a circuit carrier in various positions. These must meet the normally high requirements for intended use in the industrial sector. They are configured and designed, for example and in particular, to protect the lines or components arranged on a main part from effects of external environmental influences. They are also intended to ensure functional reliability over a long period of use and also the trouble-free operation of a system. At the same time, they should not pose a health risk.

This results in a variety of areas of application for a terminal block of the type in question which can be designed differently with regard to its intended use and can also have an adapted range of functions.

Terminal blocks of the type in question are known, for example, in their embodiment as an electrical connection terminalG from DE 3723288 A1, DE4006549 A1, as a transformer from DE9010964 A1, as an electrical connection for a circuit carrier from DE8804121A1 or DE4023915 and as an overvoltage protection device from DE3716997A1.

Electrical terminal blocks of the type in question have at least one line, for example for the transmission of a medium, a signal or a current, which is arranged or held on a main part. The main part can be formed in various ways, wherein it has at least one portion that consists of a polymer or comprises a polymer.

Polymers established themselves very early on in the industrial sector as economical and easily moldable materials for various areas and tasks and cover a very wide range of possible applications.

However, the problem with plastic materials is that they can have a high environmental impact.

### SUMMARY

In an embodiment, the present invention provides a terminal block, comprising: a line with a main part on which the line is arranged, the main part having a first portion comprising a polymer composition, wherein at least one component of the polymer composition comprises at least one of: secondary polymer raw material, biodegradable polymer, bio-based polymer.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a first exemplary embodiment of an ID support as a component of a terminal block according to the invention, the holding body of which is formed by a film body with an upper part and a lower part, in a perspective view and in schematic representation, wherein the components of the ID support are shown at a distance from one another,

FIG. 2 shows the exemplary embodiment of an ID support as a component of a terminal block according to the invention from FIG. 1 in the same view and representation as in FIG. 1, wherein the individual layers of the film body are brought close to one another,

FIG. 3 shows a second exemplary embodiment of an ID support as a component of a terminal block according to the invention, in which the upper part is formed from a film body and the lower part from an extruded body, in otherwise the same view and representation as the exemplary embodiment shown in FIG. 1,

FIG. 4 shows, in a schematic front view, in a state of attachment to a cylindrical main part to be identified of a terminal block according to the invention, a third exemplary embodiment of an ID support according to the invention in which the upper part and the lower part of the holding body are formed from a round body and are held by means of holding means on an object to be identified, wherein a transparent layer as a coating covers an ID attached to the upper part,

FIG. 5 shows, in a schematic front view in a state attached to a cylindrical object to be identified, a fourth exemplary embodiment of an ID support as a component of a terminal block according to the invention, in which the holding body is formed from a film body which is arranged on a cylindrical object, wherein the ID is arranged on a side of the body to be identified which faces away from the main part of a terminal block according to the invention which is to be identified,

FIG. 6 shows, in a schematic front view in a state attached to a cylindrical main part of a terminal block according to the invention to be identified, a fifth exemplary embodiment of an ID support as a component of a terminal block according to the invention, in which the holding body is again formed from a film body, wherein the ID is arranged on a side of the body to be identified which faces the main part of a terminal block according to the invention to be identified,

FIG. 7 shows, in a schematic front view in a state attached to a cylindrical main part of a terminal block according to the invention to be identified, a sixth exemplary embodiment of an ID support as a component of a terminal block according to the invention in which, in an attached state in which it is attached to the object to be identified, a portion of the free end of the upper part sectionally overlaps a portion of the further free end of the lower part,

FIG. 8 shows, in a schematic front view, the sixth exemplary embodiment of an ID support as a component of a terminal block according to the invention in a longitudinal extension,

FIG. 9 shows, in a seventh exemplary embodiment of an ID support as a component of a terminal block according to the invention, the holding body of which is formed with an upper part and a lower part which are folded at a fold line formed in a connecting region and face one another in a perspective view and in a schematic representation analogous to FIG. 1,

FIG. 10 shows an eighth exemplary embodiment of an ID support as a component of a terminal block according to the invention in an attached state in which it is arranged on a container, in a side view and in a schematic representation analogous to FIG. 1,

FIG. 11 and FIG. 12 show an identification mat as a component of a terminal block according to the invention with different ID supports in different views (FIG. 11—a perspective view; FIG. 12—an end view), in each case again in a schematic representation,

FIG. 13 shows a further embodiment of an ID support as a component of a terminal block according to the invention in an arrangement of an identification mat in a schematic representation in a perspective view of an upper side,

FIG. 14 shows an exemplary embodiment of an embodiment of an ID support as a component of a terminal block according to the invention in a schematic perspective view to illustrate the conductors or conductor bodies and the further details, again in a schematic representation,

FIG. 15 shows a further exemplary embodiment of a terminal block according to the invention in a perspective view to illustrate electrical conductors or conductor bodies, again in a schematic representation,

FIG. 16 shows an exemplary embodiment of a terminal block according to the invention in a sectional view to illustrate electrical conductors or conductor bodies, again in a schematic representation.

### DETAILED DESCRIPTION

In an embodiment, the present invention improves the environmental balance of a terminal block, in particular for industrial use, or its production.

In an embodiment, the present invention departs from an approach of reducing the use of a polymer obtained from a fossil raw material in order to use the fossil raw materials to only a reduced extent.

Furthermore, the invention distances itself from the approach of replacing a polymer with another material.

The invention achieves the object posed for it by means of a material approach to reduce the environmental impact. The invention achieves the object by increasing the environmental compatibility of a terminal block in that the employed polymer is a polymer composition, wherein at least one component of the polymer composition consists of one of the following materials or has at least one of the following materials: secondary polymer raw material, compostable or biodegradable polymer, bio-based polymer.

Therefore, the invention is based on choosing from a selection of polymer materials to form a polymer composition according to the invention which are used alone or in combination to increase the environmental compatibility of a terminal block according to the invention or to reduce its environmental impact.

The invention achieves this by providing a selection of materials that are recycled or produced from renewable raw materials or that are biodegradable. The selection is therefore not limited to a specific one of the aforementioned materials, so that they can also be combined with each other within the scope of the invention. In this respect, it is possible according to the invention for the polymer composition to be a secondary polymer raw material, or a biodegradable polymer, or a bio-based polymer, or a mixture of at least two, in particular all, of the aforementioned polymers, or has such materials or such a mixture.

Within the scope of the invention, a polymer composition can consist of at least one of the aforementioned materials, but may also contain other material additives, such as additives or other polymers or polymer components. According to the invention, composite materials can also be used for a polymer composition according to the invention.

Furthermore, the invention makes it possible to mix the aforementioned materials with other materials, for example additives or also primary polymers. Preferably, however, the proportion of primary polymers should be kept low for the sake of better environmental compatibility, so that these are preferably not mixed with the aforementioned materials.

The invention therefore has the advantage of not only being able to significantly reduce the environmental impact, but also to considerably reduce the burden on raw material resources. Furthermore, the invention makes it possible to provide terminal blocks for industrial use which are subject to high requirements for their usability in this sector, e.g. dielectric strength, fire protection and electrical insulation, which are usually realized with primary materials.

To this end, the invention initially proposes replacing a polymer that was produced from a fossil raw material with a polymer composition, for example and in particular consisting of or comprising a secondary polymer raw material, in order to thereby extend the usability or recyclability of fossil raw materials.

Within the scope of invention, polymers that are obtained from fossil raw materials are also referred to as polymer primary raw materials or primary polymers according the invention. Accordingly, polymers that are obtained by recycling primary polymers are referred to as secondary polymer raw materials or secondary polymers within the scope of the invention. These can, for example and in particular, have a chemical structure specific to them, e.g. molecular chains, by means of which they can be distinguished from primary materials.

Furthermore, within the scope of the invention, a portion can also be an element, a component, an assembly, an in particular non-destructively separate or separable component, or a region of a terminal block according to the invention.

In addition, within the scope of the invention, the invention provides polymers for a terminal block that are highly environmentally compatible in that they are biodegradable polymers. These polymers are characterized by the fact that they are particularly easy to compost, preferably without the use of additives for composting. This makes their disposal in particular very environmentally friendly. These also include primary polymers that are biodegradable. According to the invention, a secondary polymer that is also biodegradable is referred according to the invention as a secondary polymer raw material.

Furthermore, the invention provides bio-based polymers for a terminal block or its production, which can also be designated as technical biopolymers and are produced from biogenic raw materials, preferably renewable plant-based raw materials. Biowaste can also be used for this purpose, whereby sustainability can be increased or enhanced according the invention.

According to the invention, bio-based or biogenic raw materials serve as the basis for a polymer composition of a terminal block, which in turn results in an excellent environmental balance. Renewable raw materials such as rapeseed and corn are available and can be grown in large quantities. A bio-based polymer that is biodegradable is particularly environmentally friendly. According to the invention, such materials are associated with a bio-based polymer.

Bio-based polymers can be obtained for industrial use from carbohydrates such as: Sugars, starch, proteins, cellulose, lignins, fats and vegetable oils. Examples of bio-based polymers are polybutyrate adipate terephthalate (PBAT), so-called starch-based biodegradable blends or polylactide (PLA), polyhydroxyalkanoates (PHA), cellulose derivatives, e.g. cellulose esters (CA and cellulose butyrate (CAB), so-called biodegradable polyesters as well as starch derivatives. They also include bio-polyethylene and can match the properties of a conventional polyethylene based on a fossil raw material (primary polymer), although they may not be readily biodegradable as a result.

Within the scope of invention, biodegradable means in particular that the degradation in question takes place by means of a chemical process in which microorganisms present in the environment convert the material into natural substances such as water, carbon dioxide and compost (artificial additives are not required). The process of biodegradation depends on the environmental conditions (e.g. location or temperature), the material and the applications. Within the scope of invention, these polymers include, among others, the aforementioned PBAT, PBS, PLA and PHA.

Bio-based polymers can achieve and even surpass the properties of primary polymers. This makes a bio-based polymer an excellent, and in particular equivalent, substitute.

Within the scope of invention, these recyclable materials can sometimes be enriched with additional properties by means of additives based on fossil and renewable raw materials so that, compared to conventional polymers, further, possibly specific material properties can be produced with regard to a desired labelability or printability, light resistance, water vapor permeability or biodegradability. These polymers therefore open up a broad spectrum of usability through a specific adaptation of the material, as described below.

The invention advantageously leads to a significant improvement in the ecological balance of a terminal block formed according to the invention by significantly reducing the CO₂ emissions or CO₂ environmental pollution associated with production, recycling or disposal. It therefore promotes a low carbon footprint and ensures greater sustainability in the use of fossil raw materials and the polymers according to the invention.

In a surprising manner, it was revealed that the quality of realization or the quality of a terminal block according to the invention can be maintained at the same level despite reduced CO₂ pollution. In a surprising manner, the invention has revealed that polymers from a secondary raw material can be used according the invention which represent an equivalent substitute to a polymer produced from a fossil raw material.

The invention has the advantage that recycled polymers can be used for high-quality products or components or assemblies as well as portions thereof. The invention therefore opens up a broad field of application for secondary polymers not within an industrial spectrum so that their use is not limited exclusively to packaging purposes or fields of application with low requirements.

In this respect, the invention makes it possible to significantly reduce the CO₂ impact on the environment by opening up a wide range of applications for secondary polymers.

To realize a terminal block according to the invention, the invention can use a selection from a variety of polymers such as polycarbonate, acrylonitrile-butadiene-styrene, polymethyl methacrylate, polystyrene, polyetherimide, polyethersulfone, polysulfone, polyphenylene oxide, styrene-acrylonitrile, polystyrene, polymethyl methacrylate, polypropylene, polyethylene, thermoplastic polyurethane, polyacetal, polyethylene terephthalate, polybutylene terephthalate, polyarylates, polysulfones, polyphenylene sulfide, polyether ketone, polyimides, polyetherimide, polyphthalamide, polyoxymethylene, polyether ether ketone and/or polyamide, or preferably and/or PA 66.

An advantageous further development of the invention provides that at least a first portion consists of the polymer composition, and a second portion consists of a different material, in particular a second polymer, or has such.

This leads to the advantage that portions can be optimized with regard to their function by using a functionally appropriate material; within the scope of the invention, preferably an appropriately adapted polymer. The use of different polymers promotes high functional reliability as well as good environmental friendliness and recyclability. In addition, the different materials can be used to form a terminal block by means of a producing method, which leads to both economic and handling advantages.

For a very economical production of terminal blocks, the invention also provides, inter alia, the use of a thermoplastic so that, according to an advantageous further development of the invention, at least the polymer composition is a thermoplastic polymer, in particular a polypropylene material or a polyethylene material, a polyethylene terephthalate material, a polyvinyl chloride material or a combination of at least two of the aforementioned materials, or is based thereon.

Thermoplastics have the advantageous property of good formability and processability since they can soften to the point of flowing, for example, when heat is applied and are therefore easy to form. After a cooling phase, they become solid again and retain their shape. According to the invention, polyethylene, polypropylene, polystyrene, polyvinyl chloride, polyamides, polycarbonates, polyethylene terephthalate, polymethyl methacrylate or a mixture of at least two of these materials can therefore be used.

According to the invention, the secondary polymer raw material can be a polymer recyclate, in particular a reused or recycled polymer, or can have such a polymer recyclate, whereby the sustainability of these materials is improved. To this end, a corresponding advantageous further development of the invention relates to the fact that the polymer recyclate is a recycled polymer or has such a polymer which is based, for example and in particular, on a post-industrial material.

A reused polymer has the advantage that it can be reused for a terminal block according to the invention, especially after loosing shape. For example, and in particular in the case of a thermoplastic, the shape can be lost by applying heat and then used for a terminal block according to the invention. Sustainability can advantageously be increased if the polymer recyclate is formed from a post-industrial material or has such a material.

Post-industrial materials are obtained in particular from industrial waste that is inter alia unavoidably generated during a producing process, for example. These can, for example, accumulate during the setup of a production plant or machine, e.g. in the form of sprues as scrap, and are therefore ready for recycling.

Industrial plastic waste is often available in large quantities and is advantageously unmixed, which means that sorting or cleaning effort can be kept to a minimum, and it is then immediately available for recycling. For example and in particular, said waste is shredded and can then be reused almost immediately to form a terminal block according to the invention.

Within the scope of invention, in a further advantageous development of the invention, it is taken into account that the polymer recyclate equals the quality of the material properties of the primary raw material on which it is based.

As a result, the properties of the aforementioned materials do not differ or differ only insignificantly from one another, which means that there are no material restrictions due to the choice of material.

According to the invention, this can be achieved by recycling a polymer as a raw material by breaking it down by pyrolysis into its original monomers or other materials that can be recycled, in particular petrochemically. The latter include methanol and synthesis gases, for example.

In order to obtain monomers, it is provided according to the invention that recycling is carried out with a plastic that is as pure as possible. This makes it possible within the scope of the invention to recover petrochemical raw materials as well as monomers.

Furthermore, it is possible within the scope of the invention to obtain gases, waxes and oils that are equivalent to raw materials and can be accordingly utilized from in particular mixed plastic waste by means of degradative extrusion. This advantageously makes it possible to recycle polymers whose materials are difficult to separate.

The material properties can be specifically adapted through additives. To this end, a further advantageous development of the invention provides that at least one additive, in particular a further polymer and/or a master batch, is added to the secondary polymer raw material. According to the invention, this makes it possible to adapt the material specifically and optimally to certain requirements for an application.

Within the scope of invention, the term “master batch” is to be understood as an additive or a composition of additives in the form of granules, in particular with an added colorant. These are used for coloring or to change the material properties. Master batches make it possible to concentrate several additives together. Compared to powdered additives, master batches advantageously increase technical process reliability and ensure good processability.

In addition to coloring, for example UV stabilization, flame protection, antistatic or antiblocking properties can be precisely implemented in line with requirements. Other important material properties are in particular:
chemical, e.g. with regard to resistance to in particular aggressive media, odor formation, environmental/health neutrality and the like;
thermal, e.g. with regard to a melting and continuous use temperature as well as a coefficient of thermal expansion;
mechanical, e.g. with regard to a specific density, the design as crystalline or amorphous, a resistance to fatigue, the achievement of a desired stiffness, hardness and strength and the like.

A sometimes important property for industrial applicability in this context is, among other things, the aging and UV resistance of a polymer.

Against this background, in a further advantageous development of the invention, it is provided that at least the biodegradable polymer is configured and designed in such a way that it is UV-resistant. Accordingly, further embodiments of a first polymer can be or become correspondingly designed.

In order for at least the polymer composition of a terminal block according to the invention to have good recyclability or reusability, the components in question should meet the corresponding requirements of easy recyclability or compostability. In this context, it is provided within the scope of the invention that at least the compostable/biodegradable polymer fulfills at least the requirements according to DIN CERTCO DIN EN 13432 in the version valid in 2021.

Polymers can be used in various embodiments to realize a terminal block according to the invention. Such polymers can be used, for example, to form a transparent portion. For this purpose, in a further advantageous development of the invention, it is provided that at least one transparent portion of the terminal block or its main part is formed by the polymer composition which comprises at least one biodegradable polymer or is formed therefrom.

In order to realize good transparency, in a further advantageous development of the invention, it is provided that at least one transparent portion has an opacity of 0.6 haze according to ASTM D 1033 with regard to the version of the issue date in calendar year 2018. This makes it possible for the regions covered by a transparent portion to be easily detectable through the transparent portion, for example and in particular by means of a sensor. The invention therefore makes it possible to provide an equivalent substitute for a conventional polymer, be it polypropylene, PVC or polyester, in particular with regard to transparency.

In order to be able to achieve this using a bio-based polymer, the invention proposes that the transparent portion should not exceed the size of a layer thickness.

In a further advantageous development of the invention, it is provided that the transparent portion has a thickness of less than or equal to 200 μm, in particular 150 μm, preferably 115 μm. According to the invention, the thickness of the transparent portion is relative to the direction in which it renders a region that is covers optically detectable. The thickness is the smallest dimension with regard to the geometric dimensions of the transparent portion.

In order to achieve very good compostability of a polymer composition, it is provided in a further advantageous development of the invention that the polymer composition, in particular the biodegradable polymer, is based on or has a cellulose acetate, in particular a secondary acetate obtained therefrom, preferably a diacetate.

As already described at the beginning, it is possible for a bio-based polymer to have the properties of a conventional polymer and therefore realize virtually identical characteristics.

Against this background, in a further advantageous development of the invention, it is provided that at least the bio-based polymer is configured and designed as a drop-in polymer. The invention therefore makes it possible to produce conventional polymers, whose production is based on a fossil raw material, from a renewable raw material. According to the invention, the following materials, for example and in particular, are suitable and therefore intended for this purpose: Bio-PET, Bio-PP, PLA and PEF as already explained above.

The line of a terminal block according to the invention can be realized in many ways, as already mentioned at the beginning. Accordingly, within the scope of the invention, a line can be used to transfer or guide media along a predetermined path or channel.

Against this background, in an advantageous development of the invention, it is provided that the line is configured and designed by a conductor body for transmitting electrical energy or electrical signals/data and/or photometric signals or data. Such conductor bodies are formed, for example and in particular, by means of wires or braids as well as by means of plate-shaped or strip-shaped strips and the like, which in turn consist of a copper material or have such a material. This advantageously makes it possible to conduct, in addition to electrical energy, in particular electrical as well as photometric signals. The invention therefore also makes it possible to transfer data by wire.

Within the scope of invention, it is therefore possible, for example and in particular, for the conductor body to be configured and designed as a fiber optic according the invention. This opens up broad fields of application for the invention, which lie in the area of network technology, power supply, distribution of electrical energy and the like.

Within the scope of invention, it has also been revealed in a surprising way that the invention makes it possible for a light-conducting conductor body to consist at least sectionally of the polymer composition or to have the polymer composition.

In this respect, the invention makes it possible to extend sustainability to the formation of a conductor body. In addition, the invention advantageously makes it possible to increase the environmental compatibility of a relevant terminal block. The same applies in the event that a cable or hose or the like is realized and provided according the invention by means of the main part.

Furthermore, the invention allows a terminal block according to the invention to be configured and designed in such a way that the electrical energy or the signals as well as data can be modified, for example.

The invention allows the main part of a terminal block according to the invention to be designed, configured and constructed in various ways.

The invention therefore opens up a wide range of uses so that a terminal block can be or is configured and designed, for example and in particular, as an electrical/electronic device or a module, a functional group as well as an assembly or a component or a function-supporting unit thereof.

For example, and in particular, a terminal block according to the invention can have a main part with a reservoir, which in turn can be an integral part of the line. For example and in particular, a terminal block can also form a printer or a cartridge for a print medium.

In an advantageous further development of the invention, it is provided that the main part has a housing, in particular a hollow body extending longitudinally along an axis, preferably a cylindrical, most preferably tubular, casing which is configured and designed for the arrangement, in particular for the at least sectional enclosure of the line. According to the invention, it is provided, for example and in particular, that the main part provides or forms a sheathing of a cable with at least one wire guided therein for electrical or signal transmission or conduction. It is likewise possible for the aforementioned wire to be a photometric conductor by means of which light quantities or light data or signals can be transferred or conducted. The invention therefore allows the main part to be designed as a cable, in the interior of which a cavity is formed to form the line or its receptacle.

In addition, the invention therefore allows the main part to have a housing or to be constructed or designed as a housing, in the interior of which a cavity is formed for accommodating or arranging electrical or electronic components, parts, line elements, as well as corresponding assemblies.

The invention therefore succeeds in protecting such components of a terminal block according to the invention, in particular from external environmental influences. This protection can, for example, lie in avoiding short circuits or being able to form clearance and creepage distances appropriate for the application. In this context, the invention provides that the main part, in particular the housing, is configured and designed to be electrically insulating, and in particular is formed at least sectionally from an insulating material or has such a material.

As previously mentioned, it is allowed within the scope of invention for the main part of a terminal block according to the invention to be designed in various ways. In this respect, in a further advantageous development of the invention, it is provided that the main part or the housing is configured and designed as an electrical housing for enclosing at least one electrical and/or electronic component, or the main part or the housing is configured and designed as an electrical or signal/data line with a sheath forming a protective/insulating sheath for the cable.

In this way, the invention manifests its advantages in particular in industrial applications. For example and in particular, the main part can be configured and designed according to the invention as a connection housing, terminal block, as a housing for holding/enclosing a circuit carrier or a printed circuit board, which in turn can be equipped or indeterminate.

Furthermore, the invention makes it possible for conductor tracks to be laid out in the housing as a line, which serve to conduct electrical currents, signals as well as data between two connection points. At least one electrical or electronic component can be arranged in between which is used to measure, evaluate, convert, amplify, reduce signals/data/electrical currents and the like.

In this respect, a terminal block according to the invention can be realized, for example and in particular, as a power supply unit, current transformer as well as a switching, distribution, measuring or safety device, wherein the list is not exhaustive.

Against this background, a further advantageous development of the invention provides that the main part or the housing can be equipped or is equipped with at least one electrical or electronic component which is configured and designed for an electrical or data/signal connection of at least a first connection point and a second connection point and provides an electrical current applied to the first connection point, in particular in the same, or modified, or converted, or amplified, or reduced, or stabilized, or the same form at the second connection point.

Among other things, the invention takes into account that a terminal block formed according to the invention can be held or arranged in a defined manner in that the main part or the housing is configured and designed to snap onto a mounting rail. According to the invention, this makes it possible to securely hold the main part of a terminal block according to the invention, for example on a wall or in or on a switch cabinet or meter cabinet. Accordingly, a plurality of corresponding terminal blocks can also be arranged on a mounting rail. Mounting rails are known in many forms, for example and in particular in the form of a top-hat rail.

Moreover, in a further advantageous development of the invention, it is provided that the main part has a mounting rail which is configured and designed for the arrangement of electrical/electronic components or devices, in particular on a switching cabinet wall. Furthermore, within the scope of the invention, the aforementioned housing of the main part can be arranged on this mounting rail. The invention therefore also allows a mounting rail to be realized with the materials as mentioned herein.

Advantageously, the invention provides that parts or components for a mounting rail can also be realized according to the invention by means of the polymer composition. For this purpose, in a further advantageous development of the invention, it is determined that the main part has a mounting rail and at least one of the following components: an end cap body for the mounting rail which can be plugged or clipped onto a free end of the mounting rail; a cover body which extends longitudinally between a first and a second free end of the mounting rail in order to cover the mounting rail at least sectionally and which can be arranged or is arranged removably on the mounting rail, in particular can be plugged or clipped on, preferably can be latched or is latched on, and is accordingly configured and designed for this purpose; a separating body for the mounting rail which can be arranged or is arranged on the mounting rail for separating sections, in particular can be plugged on or pushed on, preferably can be snapped on or is snapped on, and is accordingly configured and designed for this purpose.

In a further advantageous development of the invention, a further variant of a terminal block according to the invention is characterized in that the main part, in particular the housing, is configured and designed as an electrical/signal/data connection, in particular for an electrical conductor or fiber optic, to a circuit carrier, in particular a printed circuit board. According to the invention, it is therefore possible to configure and design a terminal block, for example and in particular for a connection for a and on a cable and also a printed circuit board connection.

Within the scope of invention, an electrical conductor also comprises a conductor that is configured and designed to transmit electrical signals or data.

In industrial applications, it is often very important for terminal blocks to be labeled or identified so that, for example and in particular, they can be accordingly identified. In many cases, an ID or marking cannot be applied directly to a terminal block since the surface available there is either inaccessible or poorly accessible or unsuitable for the direct application of a marking.

Against this background, in a further advantageous development of the invention, it is determined that the main part has an ID support to whose holding body an ID can be attached or is attached. This leads to the advantage that the holding body for attaching an ID can be optimally configured and designed according to the invention. Label supports are known, for example, from DE102013113328, DE102009014694, DE102019105520, DE102019105526, DE102013109837.

This makes it possible to combine an ID support with the aforementioned design options of a main part. Accordingly, the ID support can be arranged, for example and in particular, on the housing. According to the invention, the ID support can be formed by a plurality of materials as mentioned above. In particular, it is possible to realize the ID support at least sectionally by means of the polymer composition as described above. According to the invention, this provides an ID support for a variety of applications, particularly in the industrial sector.

Within the scope of inventions, for easier handling, it is provided that the ID support is configured and designed in such a manner that it is removably held on the main part, in particular the housing in an attached state, in particular non-destructively, preferably tool-free, in particular in a form-fit and/or integrally bonded.

According to the invention, an attached state is to be understood as a state in which the ID support or its holding body is arranged on the main part or the housing as intended for the purpose of labeling it.

In this sense, the invention also allows an ID support or its holding body to be attached in a simple manner, in particular without tools.

To facilitate attachment of the ID support, a further advantageous development of the invention provides that the main part or the housing has a recess, in particular a groove, for the ID support, wherein the holding body of the ID support is configured and designed in such a way that it is removably held in or on the recess in an attached state, in particular non-destructively, preferably tool-free, in particular in a form-fit and/or integrally bonded. The invention therefore makes it possible to easily attach or position the ID holder on a housing or main part. In particular, this attachment can be automated.

In order to be able to hold the ID support securely in a groove, in a further advantageous development of the invention, it is determined that the holding body of the ID support has an expanding foot which is elastically deformable with respect to its expansion, wherein in particular at least the expanding foot is made of or consists of the polymer composition. The invention therefore makes it possible to securely hold the ID support or its holding body on a housing or in the main part in a simple manner by means of elastic or plastic deformation of the expanding foot. The use of the polymer composition to form an expansion foot makes it possible, for example, to design a region for the ID with a higher-grade material or a different type of material that is intended to optimize to accommodate an ID. The invention also allows the holding body or the ID support to be completely realized or realizable by the polymer composition or by different materials of the polymer composition. Thus, within the scope of the invention, it is possible to realize individual regions or portions of an ID support correspondingly optimized for its intended use.

According to the invention, a holding body can be designed in various ways; for example, it can accordingly be designed in a strip-like or film-like manner. According to the invention, in a further advantageous development, it is provided that the holding body is configured and designed in such a manner that, in the attached state, a portion at a first free end of the holding body overlaps a portion of a second free end of the holding body. This can in particular be advantageous, for example, if at least a portion of a free end is to be protected from external environmental influences.

Furthermore, it is thereby possible to provide holding elements in an overlap region, by means of which the free ends are held together in order to be able to realize a secure hold on a housing. In particular, fixing materials or elements, be it adhesives or Velcro elements, can be arranged at the free ends.

Within the scope of invention, the free ends are formed as such, in particular before they are attached or outside of an attached state.

The invention also makes it possible that the upper side and lower side of a holding body can be designed differently. For example, an upper side can be well labeled or optimized for the arrangement or attachment of an ID. Furthermore, an underside can be optimized to be securely held on a housing by means of a material according to the invention which, for example and in particular, has increased elasticity. Moreover, according to the invention, it is possible to realize the side that is optically of secondary importance with a correspondingly inexpensive material.

Against this background, the invention makes it possible to use composite materials in order to be able to optimally design a main part or an ID support with regard to the fulfillment of its function.

Therefore, in an advantageous development, the invention provides that, in an attached state, the holding body has an upper side facing away from the main part or the housing and an underside facing the main part or the housing, wherein the upper side and/or the underside of the holding body consists of the polymer composition or has the polymer composition.

The requirements for an ID or ID support can be very diverse and correspondingly very distinctive. In order to be able to meet these requirements, an advantageous development of a terminal block according to the invention provides an ID support which is characterized by a multi-layer structure.

Each layer can be designed differently or realized with a specific material in order to enable a highly optimum fulfillment of the function of an ID support in the interaction of the layers.

For this purpose, as an advantageous development of the invention, it is provided that the holding body has a plurality of layers, and at least one of the layers consists of the polymer composition or has the polymer composition, wherein in particular at least one intermediate layer of the holding body formed between two cover layers consists of the polymer composition or has the polymer composition.

Furthermore, the invention takes into account that, for example, a region that is underneath one of the layers or underneath an ID support and is covered by the ID support or a layer of the ID support can be recognized or optically detected from the outside through the ID support despite this covering. This can be useful, for example, to allow inspection of the contents of a container which can be formed by a main part designed as a housing. Furthermore, this is advantageously makes it possible to protect an ID from external environmental influences in that a transparent layer that is attached or arranged on the ID support covers the ID.

In this respect, in an advantageous development, the invention provides that at least one layer, in particular a cover layer, has a transparent portion formed from the polymer composition or consisting of the polymer composition and, in particular, the transparent portion extends over the entire layer in at least a longitudinal and/or a transverse direction. Within the scope of invention, a cover layer covers at least a portion of the main part, in particular the housing, preferably at least a further layer of the holding body, in particular in an attached state.

The materials provided according to the invention also allow an ID support to be able to be held integrally bonded to a main part or a housing. The polymer composition, which can be used in particular to form an adhesive layer, can for example and in particular be used for this purpose.

Against this background, in a further advantageous development of the invention, it is provided that at least one layer, in particular a cover layer, is designed and configured to be integrally bonded to the main part, in particular the housing, wherein in particular the at least one layer, in particular the cover layer, has an adhesive portion wet with an adhesive. According to the invention, an adhesive is configured and designed for an integral bond.

For a flexible, for the most flexible possible attachment of an ID support to a main part or a housing, it is provided according to the invention that the holding body is formed from a film body, in particular having a plurality of layers, preferably in the form of strips.

Furthermore, the invention provides that an ID support can also be wrapped around a housing or a cable or hose and held accordingly. For this purpose, in a further advantageous development of the invention, it is determined that the holding body is configured and designed to circumferentially wrap around the main part or the housing which is shaped, for example and in particular in the manner of a body which extends longitudinally, in particular along an axis, for example and in particular as an electrical or light-conducting cable, a tube, a pipe or a rod.

Within the scope of the invention, the ID support can be configured and designed to accommodate an optically detectable ID. Furthermore, within the scope of the invention, this can also be designed with regard to the arrangement or reception of an electrical or electromagnetic ID.

Against this background, in an advantageous development of the invention, it is determined that the identification comprises an RFID transponder which is arranged on or, in particular integrally, in the holding body, in particular between two layers in the case of a multilayer structure. In this way, the invention makes it possible to detect an ID even if it is located in a non-visible region or is covered by other elements or objects.

In addition, a large number of corresponding sensors can be used for this purpose so that the corresponding detection can be automated in a simple manner. It is also possible to automatically further process the information contained in a transponder or rather for the transponders directly using information technology.

To apply an ID, the ID support can be optimized for printing or labeling. For this purpose, it is inter alia taken into account according to the invention to provide an ID region for receiving an ID, which is optimized accordingly.

An ID can be applied very economically and precisely using a printer. Against this background, in a further advantageous development of the invention, it is determined that the holding body has an ID portion which is configured and designed to be laser-printable or laser-printed for the application of an ID.

Within the scope of invention, the term “laser printable” or “laser printed” also includes the application of an ID by laser marking in which a color or contrast change or laser radiation is generated on the surface in question. According to the invention, this is achieved, for example and in particular, by carbonization of the polymer or the polymer composition. According to the invention, this yields the advantage of precise and fast generation of an ID. Furthermore, other auxiliary materials, especially printing media such as ink, are no longer required, which in turn results in further environmental benefits.

Furthermore, the invention includes the application of an ID by other means, for example and in particular by means of ink, for example and in particular by means of a pen plotter or an inkjet printer, or also using thermal transfer printing. According to the invention, the ID portion is therefore configured and designed for applying a label by means of ink as well as thermal transfer printing.

According to the invention, different materials are available for the realization of an ID portion. Within the scope of invention, it has been shown that the ID portion consists of or has, at least sectionally, in particular the polymer secondary polymer and/or the bio-based polymer and/or the biodegradable polymer. These materials ensure an effective reception of an ID or very effective printability or labelability. Alone or in any combination with each other, they can at least sectionally form an ID portion. According to the invention, one or more additives, such as another polymer or an additive, can also be added. Accordingly, the polymer composition can be used to form an ID portion.

As already mentioned above, the protection of an ID arranged on the ID support can be achieved, for example and in particular, by the holding body having an at least sectionally transparent layer which in particular at least sectionally covers an ID arranged on the holding body. Among other things, the invention therefore allows the ID to be sealed so that it is exceptionally protected against environmental influences, be as it may the effects of liquids or mechanical stresses.

As already explained above, an ID support or its holding body can be formed by means of the biodegradable polymer composition. According to the invention, in a further advantageous development of the invention, it is in particular taken into account that the transparent layer is formed from or has such a polymer composition.

Overall, the invention makes it possible to form a terminal block or an ID support using various materials, in particular the mentioned polymer compositions. Accordingly for good environmental compatibility, there are various material selection options available from the materials a polymer composition. These promise excellent sustainability and environmental compatibility.

Against this background, the invention also comprises a production method for producing a terminal block, in particular for electrical lines and/or circuits, comprising the following steps: Providing a polymer; forming a main part by molding, in particular shaping the polymer, wherein in a further step, at least one line is arranged on the main part. This is characterized in that the polymer is provided for forming at least one portion of the main part comprising a polymer composition with at least one of the materials: a secondary polymer raw material, biodegradable polymer, and bio-based polymer, and in a subsequent step, the portion of the terminal block is formed by molding, in particular primary molding, of the polymer.

The polymer can therefore consist of or have the polymer composition according to the invention. The invention thereby realizes the aforementioned advantages, which will not be repeated here, so that a reference to them will suffice. The same applies to further features which are mentioned and described above with reference to a terminal block according to the invention, which can also be transferred to or apply to a production method according to the invention, both analogously and in isolation or separately from one another or in a previously mentioned context or reference.

A terminal block according to the invention can be manufactured, for example and in particular by means of an injection molding method. For this purpose, in a further advantageous development of the invention, it is provided that an injection mold is provided for molding, into which the polymer is introduced by plastic injection molding, and a main part, in particular a housing, preferably an ID support, is molded by means of at least one cavity in the injection mold. The invention therefore enables economical and reliable production of a terminal block according to the invention.

Furthermore, in an advantageous development of the invention, it is provided that a terminal block according to the invention is produced, for example and in particular by extrusion. To this end, the invention provides that a die is provided for forming a terminal block or a portion thereof, and the polymer is extruded through the die to form the portion. As an alternative to the above-mentioned method, this also allows economical and reliable production. In particular, the invention thereby allows so-called strand components to be producible.

In order to achieve very good material properties that are equivalent to a primary polymer, a further advantageous development of the invention determines that the secondary polymer raw material is produced by recycling a polymer as a raw material, in particular by means of pyrolysis. The advantages of this have already been explained above, so that a reference thereto will suffice at this juncture.

A production method according to the invention is configured and designed in particular in such a manner that it can be used to produce a terminal block as described above with reference to the various features. In this respect, the properties or advantages are also transferred to a production process according to the invention, if applicable in an analogous manner.

Finally, the invention also comprises the use of a polymer composition so that the invention also comprises a use of a polymer for producing at least a portion of a main part of a terminal block, characterized in that the polymer used to form the portion is or has a polymer composition with at least one of the following materials: secondary polymer raw material, biodegradable polymer, and bio-based polymer. The use of the aforementioned materials is in particular correspondingly advantageous for an aforementioned terminal block as described above. The explanations relating to a producing method according to the invention also apply analogously to the use of a polymer composition according to the invention.

The invention is explained in more detail below with reference to the attached drawing, in which a selection of exemplary embodiments of a terminal block according to the invention or an associated ID support as well as their possible uses are shown as representative of a plurality of implementation options.

The features are therefore not bound to the configurations explained below and shown in the figures, but can also form ID supports or terminal blocks according to the invention when isolated from each other as well as in a varying combination.

The figures in the drawing show a schematic representation of the aforementioned exemplary embodiments of the invention. The illustrations in the figures are therefore in particular not necessarily to scale, so that the scales selected in each case in the figures may also differ from each other.

For better clarity, the representations are reduced to the elements/parts/components that support understanding.

In the figures, identical or corresponding parts/components or elements are provided with the same reference signs.

For a better overview, all elements/components/component parts are not always provided with reference signs in the figures, wherein the assignment results from the same illustration or an illustration adapted to the relevant view.

In the case of the same or a similar structure, the description is reduced below to the differences between the exemplary embodiments or representations in the figures for a better overview.

The features illustrated by the those in the figures also apply accordingly or analogously universally and also isolated from one another to various exemplary embodiments as well as to further terminal blocks according to the invention, or to a producing method according to the invention, or to a use of a polymer composition according to the invention for a terminal block or its components. The invention is therefore not limited to the embodiments or associations that are described and shown.

Furthermore, a terminal block according to the invention is also referred to as a terminal block for short in the following.

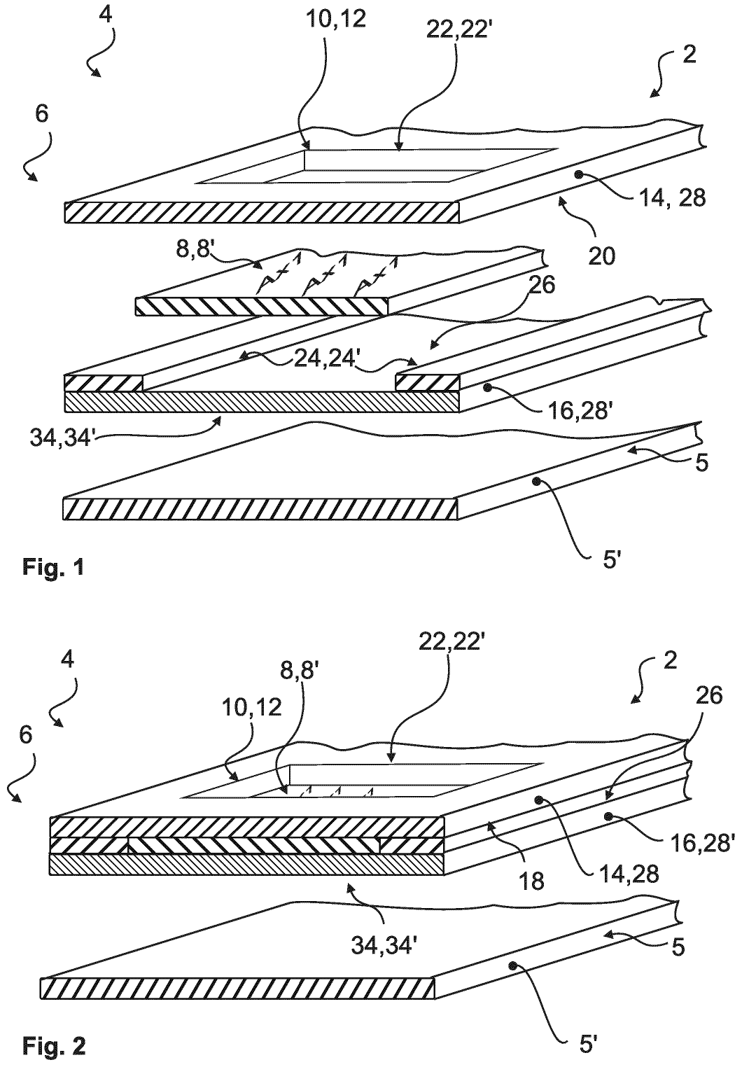

FIG. 1 and FIG. 2 show a first exemplary embodiment of an ID support 2 as a component of a terminal block 4 according to the invention or its main part 5, which is shown sectionally in FIG. 1 and FIG. 2 and schematically represented by a wall portion of a housing 5′, with a holding body 6 for holding an ID 8 arranged thereon on the housing 5′ of the main part 5, wherein the holding body 2 has a transparent portion 10 for arranging an ID 8.

The transparent portion 10 consists of a polymer composition 12 which in this case consists of a secondary polymer material. In addition, the transparent portion 10 in this exemplary embodiment is an integral component of an upper part 14 of the holding body 6.

Furthermore, the holding body 6 has a lower part 16 which, in an attached state, is arranged on the upper part 14. The holding body 6 is therefore formed from a plurality of layers 14, 16. The upper part 14 forms a cover layer that covers the lower part 16.

In this exemplary embodiment, the ID 8 is arranged between the upper part 14 and the lower part 16 in an attached state. The ID 8 consists of a laser marking 8′ which is applied directly to a side 20 of the transparent portion 10 facing the lower part 16. For this purpose, the transparent portion 10 is configured and designed for applying the ID 8 by laser marking.

The ID 8 is such that it can be visually detected from outside the ID support 2 by an optical sensor, such as a camera.

In this exemplary embodiment, the polymer composition 12 is a combination of a polymer secondary polymer and a biodegradable polymer, wherein the upper part 14 (except for the transparent portion 10) and the bottom part 16 are opaque and consist of a polymer composition 12′ that consists of a biodegradable polymer.

As shown in FIG. 1, the transparent portion 10 forms a portion 22 of the upper part 16 in this exemplary embodiment, whereby a viewing window 22′ is formed.

In an attached state, the upper part 14 is connected to the lower part 16 by an adhesive 24 arranged between them, as a result of which they are integrally bonded to one another in this exemplary embodiment.

In this exemplary embodiment, the adhesive 24 is applied to the side 26 of the lower part 16 facing the upper part 14 in the applied state, which is formed on two adhesive portions 24′.

In another alternative, the adhesive 24 can also be arranged, for example, on both of the aforementioned sides 20, 26. Furthermore, the adhesive 24 can be applied sectionally to the particular side 20, 26, as well as over the entire surface.

An adhesive 24 can be realized within the scope of the invention in many different ways, so that the possibilities mentioned in the exemplary embodiments are examples to which a realization according to the invention is not limited.

As can be seen in FIG. 1, the upper part 14 with the transparent portion 10 arranged thereon completely covers the ID 8, 8′ attached thereto in an attached state. The transparent portion 10 is again formed using a transparent bio-based polymer.

In the first exemplary embodiment, the upper part 14 and the lower part 16 are formed by plate-shaped elements 28, 28′ which are substantially congruent to each other and between which the ID 8 is arranged.

In FIG. 2, the components thereof in FIG. 1 are shown in an attached state, in that the components (4 to 28, 28′) of the ID support 2 described above in FIG. 1 are arranged next to each other and are therefore prepared for attachment to an object 8 to be identified. The transparent portion 10 protects the ID 8 from external environmental influences and also ensures optical detection of the ID 8 from the outside, for example by an optical sensor.

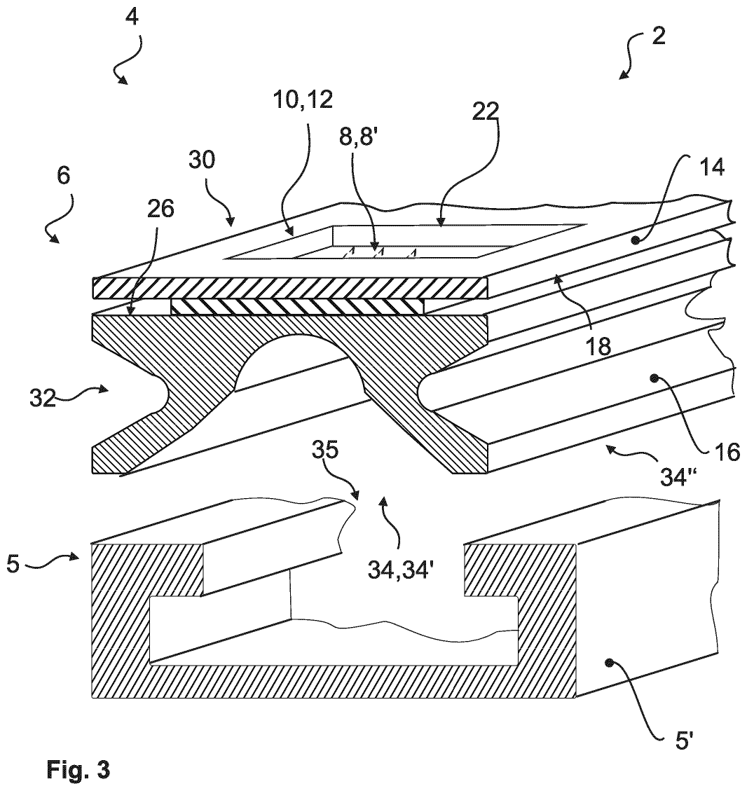

FIG. 3 shows a second exemplary embodiment of an ID support 2 as a component of a terminal block 4 according to the invention, in which the upper part 14 is formed from a film or a film body 30, and the lower part 16 from an extruded body 32. The lower part 16 is designed in such a manner that, in an attached state in which it is arranged or held on the main part 5 or housing 5′ to be identified according to the invention, it is held by its bottom side 34 on the main part/housing 5′ in a form-fit in a groove 35.

This means that the bottom side 34 of the lower part 16 is a side 34′ of the holding body 6 facing the main part 5 or the housing 5′ to be identified in the attached state. An expanding foot 34″ is formed on the underside 34 of the lower part 16 to be held in a form-fitting manner in the groove 35.

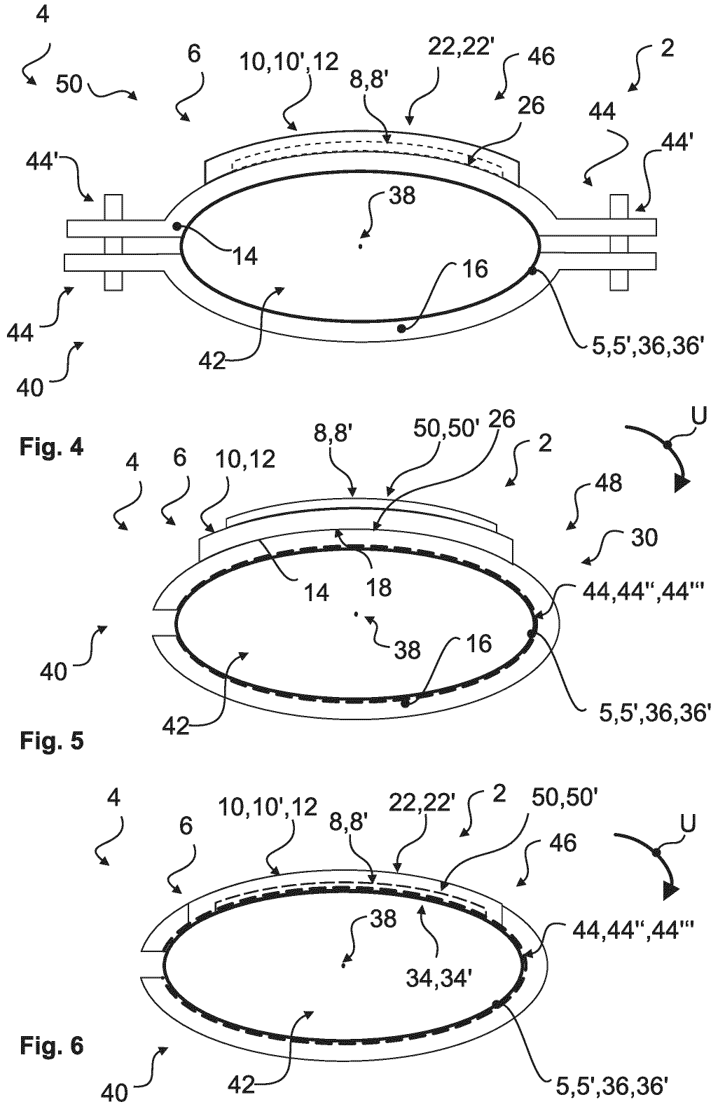

FIG. 4 illustrates a third exemplary embodiment of an ID support 2 as a component of a terminal block 4 according to the invention in an attached state. In the attached state shown in FIG. 4, the holding body 6 is arranged on a housing 5′ extending along an axis 38, which forms a cylindrical hollow body 36 for the conduction of a fluid, which is arranged between the upper part 14 and the lower part 16.

In this case, the housing 5′ (or the hollow body 36) is cylindrical in shape and has an oval cross-portion in this exemplary embodiment. It extends longitudinally along an axis 38 (body axis). Due to the selected cross-sectional representation, the longitudinal extension of the hollow body 36 is directed into the drawing plane so that a free end 40 of the hollow body 36 with the ID support 2 arranged thereon is shown.

Furthermore, the interior 42 of the hollow body 36 is hollow and forms a tube 36′ for conducting fluids or bulk materials. Within the scope of invention, fluids can be gaseous as well as liquid substances. Within the scope of invention, bulk materials include pourable substances, be it as it may in particular powders, granules, grains, cereals, gravel, sand and the like. In another application or exemplary embodiment, the hollow body (36) can be formed in the manner of a hose which provides a sheath for accommodating one or more electrical wires, and thus forms a cable 36″. In a cable, wires or braids are located inside the cable by means of which the electrical conduction takes place in that they form corresponding conductor bodies for the electrical current or corresponding signals. Signal transmission is therefore also possible with them.

The holding body 6 in turn consists of an upper part 14 and a lower part 16, which are formed from the polymer composition 12 in a shell shape and are held against one another by means of holding means 44. In this case, the holding means 44 are designed as a screw connection. Within the scope of the invention, the holding means 44 can also comprise or be formed by snap-fit or latching means, rivets, adhesives and tapes and the like, independently of the exemplary embodiments described here.

Furthermore, it is possible to form the holding means 44 by means of a film hinge. Thus, in this exemplary embodiment, the upper part 14 is held together on the lower part 16 by means of two screws 44′, whereby they are held clamped to the hollow body 36 in the shown attached state.

The transparent portion 10 is arranged on a side 48 of the holding body 6 or upper part 14 facing away from the hollow body 36 and is formed by a coating 10′ which covers the ID 8 attached to the upper part 14 and forms a seal for the ID 8, which protects it from external influences and tampering. In this case, the coating 10′ covers the upper part 14 in a section 46 in which the ID 8 is arranged.

In this exemplary embodiment, the ID 8 is printed directly on the upper part 14 using inkjet printing. The ID 8 is arranged on a side 48 of the upper part 14 or the holding body 6 facing away from the object 36 in the attached state.

The upper part 14 and the lower part 16 each consist of the same opaque polymer composition 12 which consists of a biodegradable polymer. According to the invention, the upper part 14 and the lower part 16 (both or only one of the two) can also consist of the same polymer composition 12, 12′ as that of the transparent portion 10 and can also be transparent.

FIG. 5 illustrates a fourth embodiment of an ID support 2 as a component of a terminal block 4 according to the invention in an attached state. The holding body 4 is formed from a foil as a film body 30, wherein said holding body is arranged on the hollow body 36 to be labeled by means of holding means 44. The holding means 44 is formed by an adhesive 44″. The adhesive 44″, in turn, is an adhesive layer 44′″ (symbolized by a dashed circumferential line) which is arranged between the cylindrical hollow body 36 to be labeled and the holding body 6 and connects them to one another.

The transparent portion 10 on which the ID 8 is arranged by an ID element 50 in the form of a printed adhesive label 50′ is arranged on a side 48 (upper side 48) of the holding body 6 facing away from the cylindrical hollow body 36 to be identified in the shown attached state.

In this exemplary embodiment, the holding body 6 is configured and designed to circumferentially wrap around a cylindrical hollow body 36 to be identified, be it a cable, a hose, a rod and the like. In this exemplary embodiment, the hollow body 36 to be identified is a tube 36′.

As FIG. 5 illustrates, according to the invention, the circumferential wrapping is directed in the circumferential direction U relative to the body axis 38, along which the housing 5′ to be identified (or in this exemplary embodiment the cylindrical hollow body 36 to be identified) longitudinally extends. According to the invention, however, the circumferential wrapping need not extend over the entire circumference, but can also comprise a circumferential section and, accordingly, also extend over a partial circumference.

FIG. 6 illustrates, in an attached state, a fifth exemplary embodiment of an ID support 2 ID support 2 as a component of a terminal block 4 according to the invention, wherein in contrast to the fourth exemplary embodiment, this has an ID 8 which is arranged on the side 34′ facing the hollow body 36 to be identified in the shown attached state. The transparent portion 10 is formed integrally in a portion 46 of the holding body 6 and, in turn, provides protection and a view window 22 for the ID 8 by covering the ID 8. The ID 8 is in turn an ID element 50 in the form of a printed adhesive label 50′.

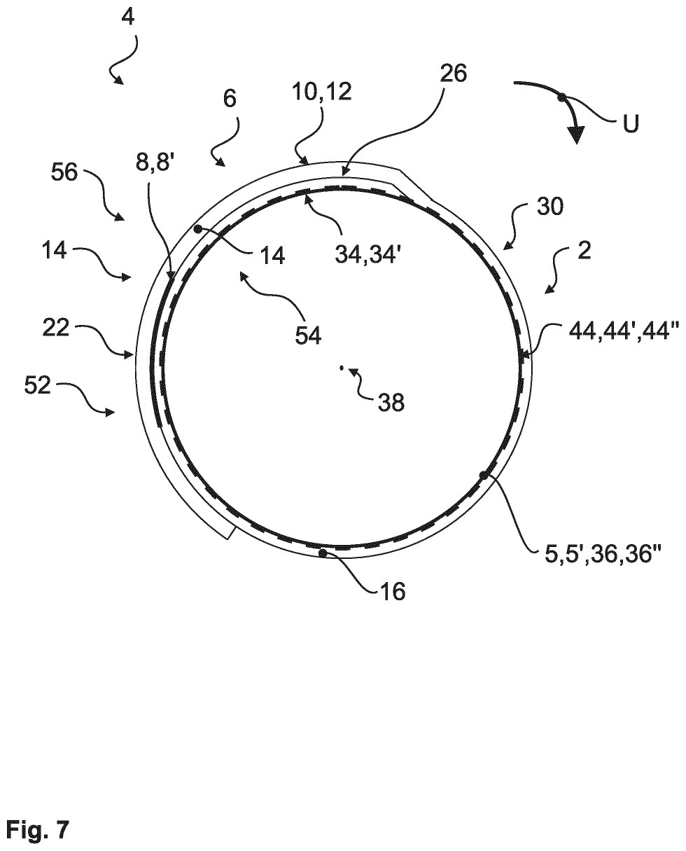

FIG. 7 shows an attached state of a sixth exemplary embodiment of an ID support 2 as a component of a terminal block 4 according to the invention, in which the transparent portion 10 extends along the upper part 14 of the holding body 4.

The holding body 6 is formed by a multilayer film body 30 and is configured and designed such that the upper part 14 and the lower part 16 are integrally connected to one another. The holding body 6 is configured and designed to wrap around the circumference of a cylindrical main part 5 or housing 5′, again be it as it may, for example and in particular, a hose, a tube 36′, a rod, a cable and the like.

In the attached state shown in FIG. 7, the cylindrical hollow body 36 to be labeled is a cable 36″ which is used to conduct electricity/data in a switching cabinet. The cable 36″ contains wires or braids for electrical conduction by means of which the electrical conduction takes place. For this purpose, the wires or braids are made of or contain a copper material. In addition to transmitting electrical energy, the electrical line can also be used to transmit data or signals.

As FIG. 7 again illustrates, according to the invention, the circumferential wrapping is directed in the circumferential direction U relative to the body axis 38 along which the main part 5 or the housing 5′, in this case the cylindrical object 36 to be identified, longitudinally extends. This exemplary embodiment illustrates that the holding body 6 is configured and designed to wrap around the entire circumference of the main part 5 or the housing 5′.

The upper part 14 is formed at one free end 52 of the holding body 6 and the lower part 16 at another free end 54 of said holding body, wherein the free ends 52, 54 are opposite ends 52, 54 of the holding body 6.

In this case, the one free end 52 of the holding body 6 overlaps the other free end 54 of the holding body 6 in an overlapping portion 56.

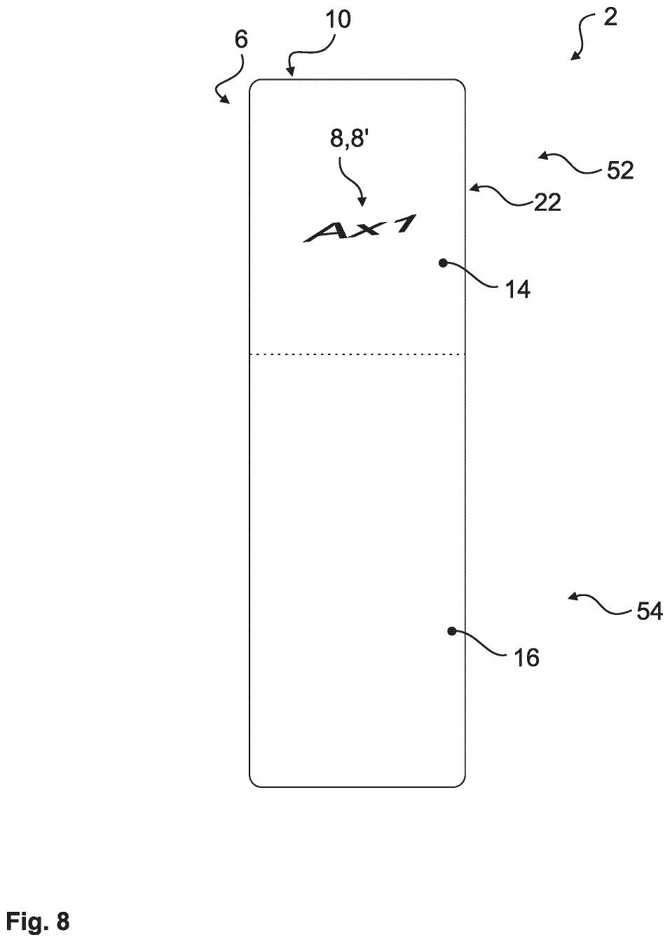

FIG. 8 again shows the sixth exemplary embodiment of an ID support 2 according to the invention from FIG. 7 in a longitudinal extension. In this case, the extension of the upper part 14 and the lower part 16 in the direction of arrangement shown, in which they are arranged side by side, as shown in FIG. 8, is dimensioned such that, in the attached state shown in FIG. 7, in which the holding body 6 is arranged on the housing 5, a free end 52 of the holding body 6 overlaps another free end 54 of the holding body 6 at least sectionally in an overlapping portion 56 (shown in FIG. 7).

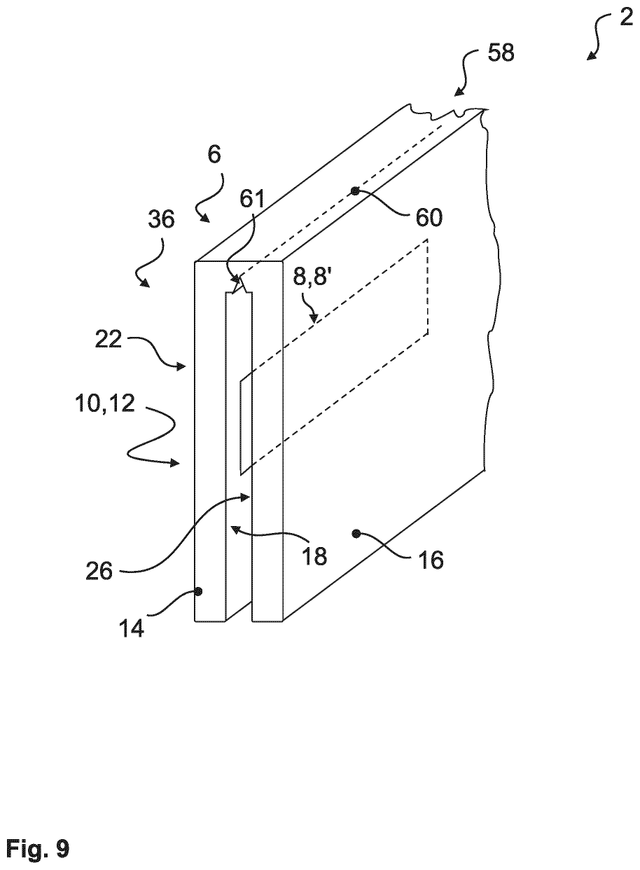

FIG. 9 shows a seventh exemplary embodiment of an ID support 2 according to the invention, the holding body 6 of which is again formed from a strip-shaped film body 30. The holding body 6 is divided into an upper part 14 and a lower part 16. In this exemplary embodiment, the upper part 14 and the lower part 16 are integrally connected to one another in a connecting portion 58.

A straight folding line 60 is formed at the connecting portion 58, along which the upper part 14 and the lower part 16 can be folded towards each other in such a way that the upper part 14 and the lower part 16 overlap sectionally in the folded state shown in FIG. 9 and are essentially congruent in this exemplary embodiment.

In this exemplary embodiment, the fold line is formed by an impression 61 which is notch-shaped and runs transversely to the longitudinal extension of the holding body 6.

According to the invention, in similar or differently designed exemplary embodiments of the invention, the folding line 60 can be formed inter alia not only by an impression 61 but also by a groove, a (linear) perforation, an embossing and the like.

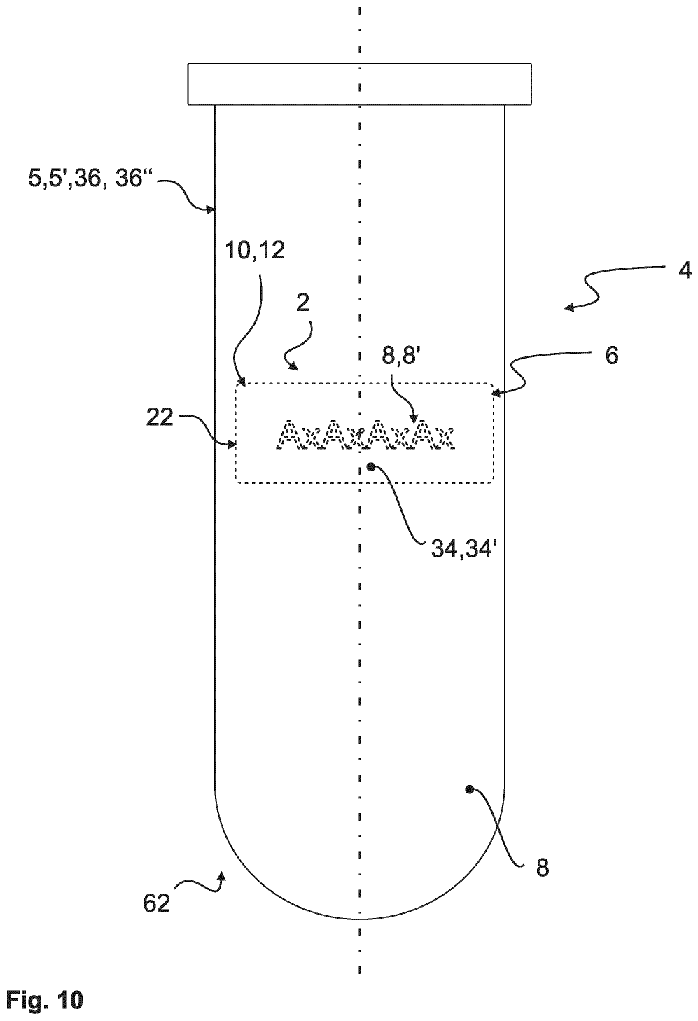

FIG. 10 illustrates an eighth exemplary embodiment of an ID support 2 according to the invention, again in an attached state, in which it is arranged on a transparent housing 5′ shaped as a container 36″.

The ID 8, 8′ is arranged on a side 34′ facing the housing 5′, which makes it easier to detect both the fill level of the housing 5′ and at the same time its surroundings, as is advantageous in production and the laboratory, for example.

Within the scope of invention, a housing 5′ does not necessarily have to be cylindrical in shape, but can also have any other shape.

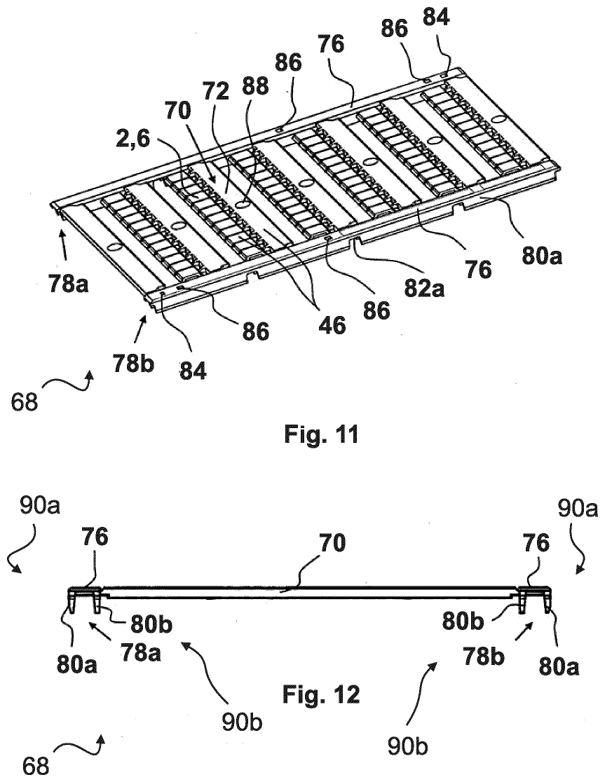

FIG. 11 illustrates a use of an identification mat 68 for providing an arrangement of holding bodies for IDs of terminal blocks 4. Accordingly, the invention also comprises a method step according to which the holding bodies 6 of ID supports 2 are initially provided in an ID mat 68, from which the holding bodies are separated or detached for attachment to a main part 5, or a housing 5′, and are then accordingly attached or arranged on the main part 5, or a housing 5′. For a better overview, the holding body 6/ID support 2 is correspondingly identified once with the relevant reference signs in FIG. 11 as representative of the others.

In this exemplary embodiment, the identification mat 68 has a plurality of ID units 70 arranged in a row one behind the other, wherein each ID unit 70 in turn has a transverse web 72 and a plurality of holding bodies 6 formed on the transverse web 72. The ID units 70 arranged in a row one behind the other are connected to each other via a frame 76 which runs laterally along the ID units 70. The frame 76 is provided on the right and left of the ID units 70 along their transverse side surfaces.

To guide the ID mat 68 in a printer in which an identification or printing of the ID units 70 takes place in the portion 46 for the ID, guide means 78a, 78b are provided on the frame 76 which, as can be seen in FIG. 12, are each formed from two webs 80a, 80b arranged parallel to one another so that the guide means 78a, 78b are substantially U-shaped. Two guide means 78a, 78b are arranged on the frame 76, wherein a first guide means 78a is arranged on the frame 76 to the left of the transverse side of the ID units 70, and a second guide means 78b is arranged on the frame 76 to the right of the transverse side of the ID units 70.

As shown in FIG. 11, several recesses 88 in the form of notches are provided along the webs 80a, 80b. Control holes 84 and identifiers 86 are also introduced in the frame 16, wherein the identifier 86 can be in the form of a 10-bit code.

The ID mat is made from a polymer composition by an injection molding method. The injection during the injection molding method takes place at the transverse web 72 of the ID units 70, wherein in the embodiment shown in FIG. 11, the injection point 88 (marked representatively once in FIG. 11) is provided centrally along the longitudinal direction of the transverse webs 72.

The portions 46 in each of which the ID is arranged, can be provided on the transverse web 72 and/or the holding bodies 6 of an ID unit 10.

The webs 80a, 80b are arranged substantially parallel to one another, as a result of which the guide means 78a has a U-shaped design in the form of a runner. The side surfaces 90a, 90b of the webs 80a, 80b are each provided with a slope, wherein in the embodiment shown herein, the webs 80a, 80b have a slope both on their side surface 90b and on their side surface 90a. The slope can extend over the entire length of a side surface 90a, 90b or only be provided in certain regions. The slopes are designed in such a manner that the cross-sectional area of the webs 80a, 80b is reduced towards their free end. The sloped side surfaces 80a, 80b facilitate easier removal of the ID mat from the injection mold in the region of the guide means 78a, 78b.

A predetermined breaking point in the form of a material reduction is formed at the connection region between the frame 76 and the ID unit 70.

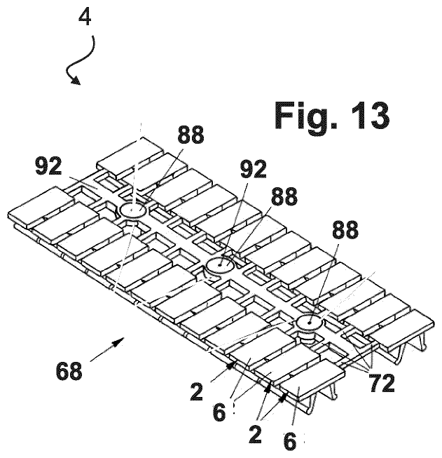

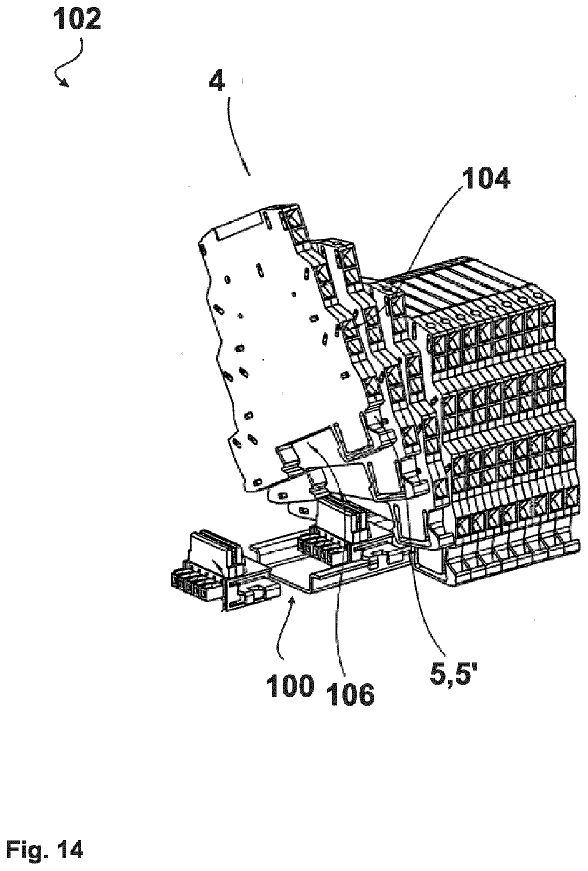

FIG. 13 illustrates a further embodiment of an ID support 2 as a component of a terminal block 4 according to the invention in the arrangement of an identification mat 68 in a schematic representation in a perspective view of an upper side (FIG. 13) and a bottom side (FIG. 14). Compared to the arrangement shown in FIG. 11 and FIG. 12, the arrangement does not have a frame. The individual holding bodies 6 of a particular ID support 2 are arranged on a supporting body 90 which has a central strand 92 from which crossbars 72 are provided for the arrangement of the holding bodies 6. The central strand and the crossbars are arranged at right angles to each other. The holding bodies can be removed from the supporting body 90 according to the procedure explained with reference to FIG. 11/12 and used for attachment to the main part 5 or housing 5′ (not shown in FIG. 13/14).

In FIG. 14, an arrangement of disk-shaped terminal blocks 4, which are arranged or can be arranged on a mounting rail 100 in a row arrangement 102, is shown as representative of a large number of exemplary embodiments of terminal blocks 4 according to the invention.

The main part 5′ of the individual terminal blocks 4 is configured and designed as an industrial electronics housing 5′ for housing electrical and electronic components, be they connections 104 (marked once representatively in FIG. 14), circuit carriers that are or can be printed circuit boards, electrical and electronic components, including as components of an assembled printed circuit board (not shown/not visible in detail in FIG. 14). The connections 104 are used to connect cables (36″, not shown in FIG. 14) for transmitting electrical current or data or signals and are accordingly configured and designed.

The housing 5′ has a latching foot 104 by means of which the terminal block 4 can be latched onto the mounting rail. The terminal blocks have electrical connections that are either connected directly to each other or to the aforementioned components, in particular a printed circuit board, via lines in the interior of the housing 4′ (not shown in FIG. 14).

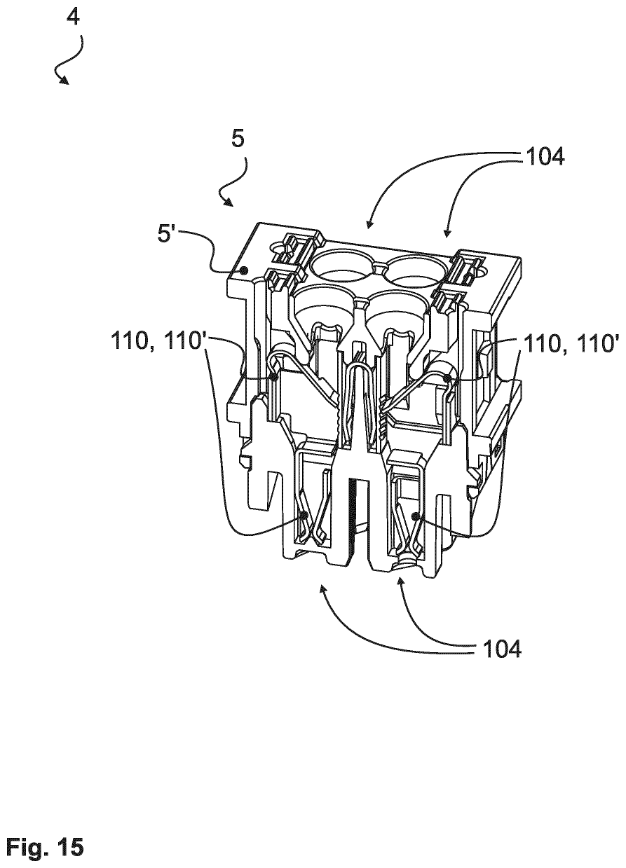

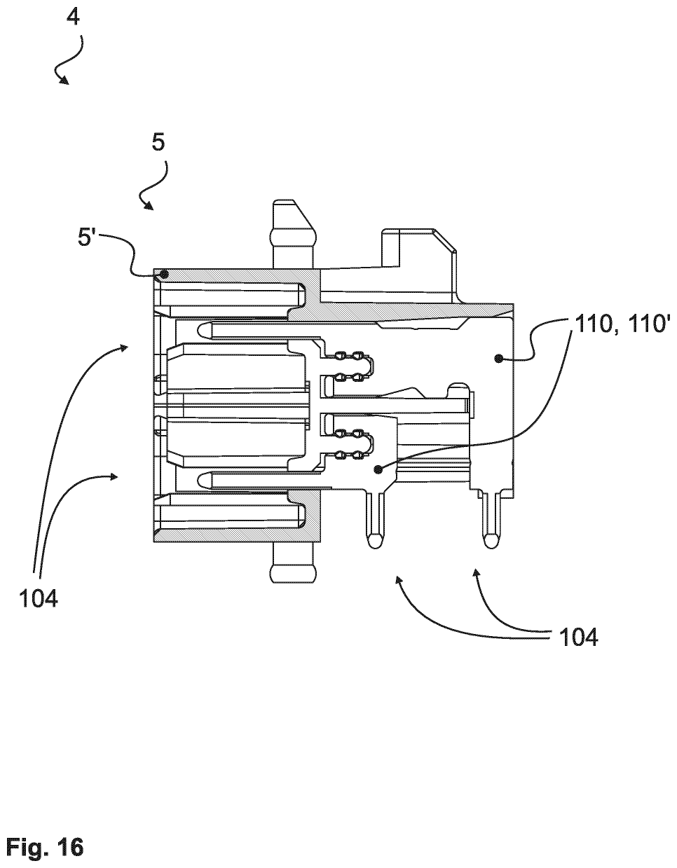

FIG. 15 shows another exemplary embodiment of a terminal block 4 according to the invention in a sectional view in a schematic illustration. The terminal block in turn has a main part 5 which in turn has a housing 5′ made of an insulating material. The housing is configured and designed as a carrier for lines 110 which, in this exemplary embodiment, are formed by means of strip-shaped or plate-shaped conductor bodies 110′ which are formed from a copper material. They are a component of connection points 104 which, in this exemplary embodiment, serve as conductor terminals for the electrical connection of cables (36″, not shown in FIG. 15) or conductor tracks of a printed circuit board. The terminal block shown in FIG. 15 can also serve as a printed circuit board termination, for example.

FIG. 16 shows another exemplary embodiment of a terminal block 4 according to the invention in a sectional view in a schematic representation which is similar to the example shown in FIG. 15. In this exemplary embodiment, the lines 110 are formed by flat, plate-shaped conductor bodies 110′ which are made of a copper material. Furthermore, the terminal block 4, in particular its main part 5/housing 5′, is configured and designed to be arranged on a printed circuit board and to form an electrical/signal/data connection to a circuit carrier, which can be a printed circuit board. In this exemplary embodiment, the terminal block 4 according to the invention therefore forms a printed circuit board connection in an arrangement on a printed circuit board.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

ID support 2
Terminal block 4
Industrial electronics housing 4′
Main part 5
Housing 5′
Holding 6
ID 8
Laser marking 8′
Transparent portion 10
Coating 10′
Polymer composition 12, 12′
Upper part 14
Lower part 16
A side of the upper part facing the lower part 20
(Transparent) portion of the upper part 22
Viewing window 22′
Adhesive 24
Adhesive portion 24′
A side of the lower part facing the upper part 26
Plate-like elements for forming the upper/lower part 28, 28′
Film body 30
Extruded body 32
Bottom side 34
Side facing the housing 34′
Expanding foot 34″
Groove 35
Hollow body 36
Pipe 36′
Cable 36″
Container 36″
Body axis 38
Free end 40
Interior of the housing 42
Holding means 44
Screws 44′
Adhesive 44″
Adhesive layer 44′″
Portion for ID 46
A side of the upper part facing away from the object
Holding body (upper side) 48
ID element 50
Adhesive label 50′
Free end of the holding body 52
Another free end of the holding body 54
Overlapping portion 56
Connecting portion 58
Folding line 60
Impression 61
Production means 62
ID mat 68
ID units 70
Crossbar 72
Frame 76
Guiding means 78a, 78b
Webs 80a, 80b
Recesses 82
Control holes 84
Identifiers 86
Injection point 88
Supporting body 90
Middle portion 92
Mounting rail 100
Row arrangement 102
Connection points 104
Latching foot 106
Cables 110
Conductor body 110′
Circumferential direction U

1. A terminal block, the terminal block comprising:
a line;
a main part on which the line is arranged, the main part comprising a first portion comprising a polymer composition,
wherein
at least one component of the polymer composition comprises at least one of:
secondary polymer raw material,
biodegradable polymer, or
bio-based polymer.

2. The terminal block of claim 1, wherein at least a first portion comprises the polymer composition, and a second portion comprises a different material comprising a second polymer.

3. The terminal block of claim 1, wherein at least the polymer composition comprises a thermoplastic polymer comprising a polypropylene material or a polyethylene material, a polyethylene terephthalate material, a polyvinyl chloride material or a combination of at least two of the aforementioned materials.

4. The terminal block of claim 1, wherein the secondary polymer raw material comprises a polymer recyclate comprising a reused and/or recycled polymer.

5. The terminal block of claim 4, wherein the polymer recyclate comprises a post-industrial material.

6. The terminal block of claim 4, wherein the polymer recyclate equals a quality of material properties of the primary recyclate on which they are based.

7. The terminal block of claim 1, wherein at least one additive comprising a further polymer and/or a master batch is added to the secondary polymer raw material.

8. The terminal block of claim 1, wherein the biodegradable polymer comprises a cellulose acetate comprising a secondary acetate obtained therefrom,
wherein at least the bio-based polymer comprises a drop-in polymer, and
wherein at least the biodegradable polymer is UV-resistant.

9. The terminal block of claim 1, wherein at least one transparent portion of the main part is formed by the polymer composition.

10. The terminal block of claim 9, wherein the at least one transparent portion comprises a biodegradable polymer.

11. The terminal block of claim 9, wherein the at least one transparent portion has an opacity of 0.6 haze of ASTM D 1033.

12. The terminal block of claim 1, wherein the line comprises conductor body configured to transmit electrical energy or electrical signals/data and/or photometric signals or data.

13. The terminal block of claim 1, wherein the main part has a housing comprising a hollow body extending longitudinally along an axis.

14. The terminal block of claim 13, wherein the housing comprises:
an electrical housing configured to enclose at least one electrical and/or electronic component,
or an electrical or signal/data cable with a sheath forming a protective/insulating jacket for the cable.

15. The terminal block of claim 1, wherein the main part or the housing is equippable with at least one electrical or electronic component configured for an electrical or data/signal connection of at least a first connection point and a second connection point, and provides an electrical current applied to the first connection point, comprising in a same, or modified, or converted, or amplified, or reduced, or stabilized, or a same form at the second connection point.

16. The terminal block of claim 1, wherein the main part comprises as an electrical/signal/data connection on a circuit carrier.

17. The terminal block of claim 1, wherein the main part has a mounting rail configured for arrangement of electrical/electronic components or devices, comprising a switching cabinet wall, and
wherein the main part comprises at least one:
an end cap body for the mounting rail which is attachable or pluggable onto a free end of the mounting rail,
a cover body which extends longitudinally between a first and a second free end of the mounting rail in order to at least sectionally cover the mounting rail, and which is arrangeable or is removably arranged on the mounting rail,
a separating body for the mounting rail which is arranged for separating portions on the mounting rail, and is pluggable or plugged on.

18. The terminal block of claim 1, wherein the main part has an ID support on whose holding body an ID is attached or is attachable,
wherein the ID support is configured to be removably held on the main part in a form-fit and/or integrally bonded, in an attached state, non-destructively.

19. The terminal block of claim 18, wherein the main part has a recess, comprising a groove, for the ID support, and
wherein the holding body of the ID support is configured to be removably held in or on the recess in an attached state, non-destructively.

20. The terminal block of claim 18, wherein the holding body of the ID support has an expanding foot which is elastically deformable with respect to an expansion thereof, and
wherein comprising at least the expanding foot comprises the polymer composition.

21. The terminal block of claim 18, wherein the holding body is configured such that, in the attached state, a portion at a first free end of the holding body overlaps a portion of a second free end of the holding body.

22. The terminal block of claim 18, wherein the holding body in the attached state has an upper side facing away from the main part and an underside facing the main part, and
wherein the upper side and/or the underside of the holding body comprises the polymer composition.

23. The terminal block of claim 18, wherein the holding body has a plurality of layers, and at least one of the layers of the plurality of layers comprises, at least sectionally, the polymer composition, and
wherein at least one intermediate layer of the plurality of layers of the holding body formed between two cover layers of the plurality of layers comprises, least sectionally, the polymer composition.

24. The terminal block of claim 23, wherein at least one layer of the plurality of layers comprising a cover layer, has a transparent portion comprising the polymer composition, the transparent portion extending over an entirety of the cover layer in at least a longitudinal and/or a transverse direction.

25. The terminal block of claim 23, wherein at least one layer of the plurality of layers comprising a cover layer is integrally bonded to the main part, comprising the housing, and
wherein the cover layer has at least one adhesive portion wet with an adhesive.

26. The terminal block of claim 18, wherein the holding body comprises a film body comprising a plurality of layers.

27. The terminal block of claim 18, wherein the holding body is configured for at least sectional circumferential wrapping of the main part, comprising the housing, which comprises a body which extends longitudinally along an axis.

28. The terminal block of claim 18, wherein the identification comprises an RFID transponder which is arranged on or integrally in the holding body, between two layers of a multilayer structure.

29. The terminal block of claim 18, wherein the holding body has an ID portion which is configured to be laser-printable or laser-printed for the application of an ID.

30. The terminal block of claim 29, wherein the ID portion comprises the secondary polymer and/or the bio-based polymer.

31. The terminal block of claim 18, wherein the holding body has an at least sectionally transparent layer which covers an ID arranged at least sectionally on the holding body, and
wherein the least sectionally transparent layer comprises the polymer composition.

32. A production method for producing a terminal block electrical lines and/or circuits, the method comprising:
providing a polymer;
forming a main part by molding, comprising shaping the polymer; and
arranging at least one line is arranged on the main part,
wherein the polymer is provided for forming at least one portion of the main part comprising a polymer composition with at least one of:
secondary polymer raw material,
biodegradable polymer,
bio-based polymer,
wherein the method further comprises forming, by primary molding of the polymer composition,
the portion of the terminal block,
wherein the secondary polymer raw material is produced by recycling a polymer as a raw material, by pyrolysis, and
wherein the terminal block comprises the terminal block of claim 1.

33. The production method of claim 32, wherein an injection mold is provided for molding, into which the polymer is introduced by plastic injection molding, and a main part, comprising a housing, is molded by at least one cavity in the injection mold, or
wherein a die is provided for forming a terminal block or a portion thereof, and the polymer is extruded through the die to form the portion.

34. A method of producing the terminal block of claim 1, the method comprising:
using a polymer to produce at least one portion of a main part of the terminal block, the polymer comprising at least one of:
secondary polymer raw material,
biodegradable polymer,
bio-based polymer.
